(19) United States
(12) Patent Application Publication
(10) Pub. No.: US 2008/0226000 A1
(43) Pub. Date: Sep. 18, 2008

(54) Method and Device for Digital Data Transmission

(76) Inventor: Raimund Meyer, Furth (DE)

Correspondence Address: PHILIPS INTELLECTUAL PROPERTY & STANDARDS, P.O. BOX 3001, BRIARCLIFF MANOR, NY, 10510, US

(21) Appl. No.: 10/565,818

(22) PCT Filed: Jul. 22, 2004
(86) PCT No.: PCT/EP2004/008199

§ 371 Date: May 28, 2008

(30) Foreign Application Priority Data
Jul. 25, 2003 (EP) 030169635

(51) Int. Cl. H04B 1/10

(52) U.S. Cl. 375/347; 375/346

(57) ABSTRACT

The present invention relates to a method for digital data transmission, wherein the transmission is effected by carrier frequency modulation and is disturbed by at least two different types of disturbance, the method comprising the following steps at the receiving end: a1) determining an estimate for the power of the received signal; a2) determining an estimate for the signal-to-noise-plus-interference ratio of the received signal; b) supplying at least the estimates determined in the steps a1) and a2) to a decision unit, which determines at least one dominant type of disturbance based on at least one predefinable decision criterion. In addition, the invention relates to a device for receiving data which are digitally transmitted by means of carrier frequency modulation, the device comprising an estimate determining device (12) for determining an estimate for the power of the received signal, a device (10) for determining an estimate for the signal-to-noise-plus-interference ratio of the received signal and a decision unit (14) which is coupled to the device (12) for determining an estimate for the power of the received signal and to the device (10) for determining an estimate for the signal-to-noise-plus-interference ratio and is arranged for determining at least one dominant type of disturbance based on the determined estimate in accordance with at least one predefinable decision criterion. The invention finally relates to a semiconductor module in which the method according to the invention is stored.

The present invention relates to a method and a device for digital data transmission, in which the transmission is effected by carrier frequency modulation such as, for example, with the mobile radio system GSM (Global System for Mobile Communication) and is disturbed by at least two different types of disturbance. The invention particularly relates to a method and a system for detecting interference signals for TDMA (Time-Division Multiple Access) and/or FDMA (Frequency-Division Multiple Access) transmission, which can at least approximately be described by pulse amplitude modulation. An approximate description by pulse amplitude modulation is there if the modulation error then occurring is smaller than 10%. In addition to this, the invention relates to a semiconductor module in which the method according to the invention is stored.

With carrier frequency based digital transmission over dispersive channels, for example, over a mobile radio channel, the transmit signal is distorted, and disturbed by noise and/or common channel interference and/or adjacent channel interference sources. Therefore, special measures for recovering the transmitted data are necessary in the receiver, which measures are generally referred to as equalization.

The efficiency of the receiver with respect to as error-free a recovery of the transmitted data as possible in essence depends on the type and extent of the disturbance in the transmission channel. For optimum equalization it is essential to have most accurate knowledge about the disturbance, for example with respect to its statistical properties.

If in the transmission channel for example a disturbance as a result of additive white gaussian noise (AWGN) dominates, other measures for optimum equalization are to be resorted to than if a common channel and/or adjacent channel interference source is present. In the former case the optimum method for equalization of dispersive channels is the maximum likelihood sequence estimation (MLSE), described in G. D. Forney Jr, “Maximum-Likelihood Sequence Estimation of Digital Sequences in the Presence of Intersymbol Interference”, IEEE Transactions on Information Theory, IT-18, 363-378, May 1972, which estimation can be performed by means of the Viterbi algorithm. In the case of a disturbance, for example due to common channel interference, methods such as for example Joint MLSE can achieve considerably better results; see for example K. Giridar et al., “Joint Demodulation of Co-channel Signals Using MLSE and MAPSD Algorithms”, Proceedings of IEEE Int. Conf. on Acoustics, Speech, and Signal Processing (ICASSP), Minneapolis, 1993, IV-160-IV-163. Furthermore, methods in accordance with EP 1 221 780 can be used with promising result.

It can thus be established that when the type of disturbance occurring on the transmission channel (noise or interference) is known, the efficiency of a digital transmission system can be considerably improved by the selection of the best suitable equalization method. In this context it is also of special importance that with TDMA transmission the ratios of disturbance may strongly vary from one time slot to the next, so that a detection of an interference signal per time slot yields the optimum efficiency.

The methods known thus far with respect to interference signal detection are predominantly based on an estimation of the signal-to-interference-plus-noise, S/(I+N) or SINR), from which the presence of an interference signal is derived. In essence four different approaches can be mentioned:
(1) interference projection IP method
(2) subspace-based SB method
(3) evaluation of the autocorrelation sequence of the received signal
(4) evaluation of the spectral properties of the received signal.

The interference projection method (1) described for example in M. D. Austin, “In-service signal quality estimation for TDMA cellular systems”, Kluwer Wireless Personal Commun., vol. 2, pages 245-254, 1995, performs an estimation of the signal-to-interference plus noise, S/(I+N), in which, however, no difference is made between a disturbance caused by for example white noise and by interference signals. This renders the method described there, which furthermore provides an estimated value only via time-dependent averaging, unusable for the application strived for here.

The subspace based estimation (2) has for its object to yield an estimate of the signal to interference ratio (SIR), described for example in “Subspace based estimation of the signal to interference ratio for TDMA cellular systems”, IEEE Vehicular Technology Conf., Atlanta, Ga., pages 1155-1159, April 1996. Knowing this parameter would be basically suitable for detecting a disturbance source by means of a comparison of the estimate of the signal-to-noise ratio with a suitably chosen threshold. However, this method is based on the estimation of a covariance matrix and thus assumes the evaluation of a usually larger number of received signal sequences (in TDMA systems: time slots). An estimation based on time slots would mean a size 1 sampling, so that this method also proves to be unsuitable for implementation.

A further method of detecting interference signals is based on an evaluation of the autocorrelation sequence of the interference signal (3) derived from the received signal, described for example in EP 1 158 684 A1 entitled: “Method and device for detecting adjacent channel interference in a transmission signal”. An evaluation of the autocorrelation properties of the interference signal, however, does not provide a reliable differentiating criterion in the case of common channel interference sources, since with real transmission systems the available channel bandwidth is usually used to a maximum extent, so that the autocorrelation value of a common channel interference signal within the bandwidth of the channel under consideration is very similar to the autocorrelation value of additive white noise.

A basically similar problem setting is found in the detection of common channel and/or adjacent channel interference sources by means of spectral analysis of the received signal (4). Whereas such a method is highly suitable, a reliable detection of common channel interference sources to detect adjacent channel interference sources is impossible, because useful signal and common channel interference signals generally have the same or a similar long-term spectrum and thus the frequency spectrum of the received signal does not represent an adequate differentiation criterion. Consequently, all the methods discussed have a high probability that a common channel interference source is erroneously not detected or an occurring white noise is wrongly interpreted as a common channel interference source.

So it is an object of the invention to provide an improved possibility, compared to the state of the art, of detecting an interference source, with which possibility particularly also common channel interference sources are recognized more reliably in essence and which, in TDMA transmission systems, makes detection possible based on the implementation of time slots. The following marginal conditions are then assumed to be fulfilled:
an (at least substantially) linear modulation method is used such as, for example, QAM (Quadrature Amplitude Modulation), PSK (Phase-Shift Keying) or GMSK (Gaussian Minimum-Shift Keying), while the modulation method mentioned last can be approximated by filtered BPSK (Binary Phase-Shift Keying),
the received signal is available as a what is called equivalent complex baseband signal,
the first Nyquist condition need not be fulfilled of necessity (this means that possibly intersymbol interference occurs),
it is not necessary to have special advance knowledge about the transmission channel; only the sending of a training sequence known in the receiver is assumed for making a receive-end estimation of the channel impulse response,
the basic noise (thermal noise, amplifier noise, quantization noise etc.) occurring in the receiver is approximately constant or at any rate very well estimable.

This object is achieved by means of a method that has the characteristic features of patent claim 1 and by means of a device that has the characteristic features of patent claim 8.

The invention is in principle based on the fact that
1) suitable features are derived from the received signal, more particularly
   an estimate for the power of the received signal P_{RX}, and
   an estimate for the signal-to-interference-plus-noise ratio (SINR);and
2) these characteristic features are supplied to a device, which, based on these features, makes a decision about the type of disturbance and then provides a smallest possible error rate.

The main implemenation of the present invention lies in the detection of common channel and/or adjacent channel interference occurring on the transmission channel, more particularly in FDMA-based transmission systems, with the aid of features contained in a received signal that is being considered.

With the method according to the invention the reliable detection of the types of disturbance of “common channel and/or adjacent channel interference”, particularly in FDMA-based digital transmission systems such as, for example, the GSM mobile radio system, is guaranteed, so that after the presence of such a disturbance has been detected, suitable measures can be taken in the receiving arrangement; for example interference cancelation particularly by adaptive filtering, or the constructive inclusion of the interference in the equalization process (for example by multi-user detection).

Furthermore, the method is eminently suitable for TDMA systems having data transmission in blocks, which is used in most mobile radio standards (for example GSM). Here a block-based estimation of the type of disturbance is highly advantageous because of properties of the transmission channel that change considerably in the course of several blocks (for example by the implementation of frequency hopping methods).

As a result, the invention makes a considerable increase of the performance of the receiver in respect of the recovery of the transmitted data. This particularly holds for the transmission when there is a strong common channel and/or adjacent channel interference source.

In a particularly preferred variant, furthermore an estimate is determined for the signal-to-interference-plus-residual-noise ratio, while the decision unit is also supplied with this estimate. This allows to determine the at least one dominating type of disturbance even more precisely.

Particularly preferred is the fact that when the estimate is determined for the signal-to-interference-plus-residual-noise ratio, at least one measure for interference reduction, particularly for interference suppression is applied to the received signal. This considerably increases the reliability of the estimate for the signal-to-interference-plus-residual-noise ratio together with the estimate for the signal-to-interference-plus-noise ratio, and an improved decision quality can be achieved.

In a preferred further embodiment, a further step is executed in that an equalization is performed of the received signal on the basis of the at least one dominant type of disturbance determined in step b).

In a real digital transmission system the data are usually disturbed by two types of disturbance, that is to say, by noise, on the one hand, and common channel and/or adjacent channel interference, on the other. The estimate for the power of the received signal admits of conclusions as to the noise, whereas the two other estimates admit conclusions as to the common channel and/or adjacent channel interference.

If there are a plurality of received signals (antenna diversity), preferably the estimation steps and the determining of the at least one dominant type of disturbance are carried out in the decision unit for each received sub-signal. Furthermore, also preferred is the equalization of the received signal for each received sub-signal separately on the basis of the at least one type of disturbance established as dominant. This measure causes the advantages of the method according to the invention to be maximized in the case of antenna diversity.

Finally, the present invention relates to a semiconductor module in which the method according to the invention is stored.

Further advantageous embodiments may be inferred from the dependent claims. In the following, examples of embodiment according to the invention will be described in more detail with reference to the appended drawings, in which:

FIG. 1 shows in a block circuit diagram a first example of embodiment without antenna diversity;

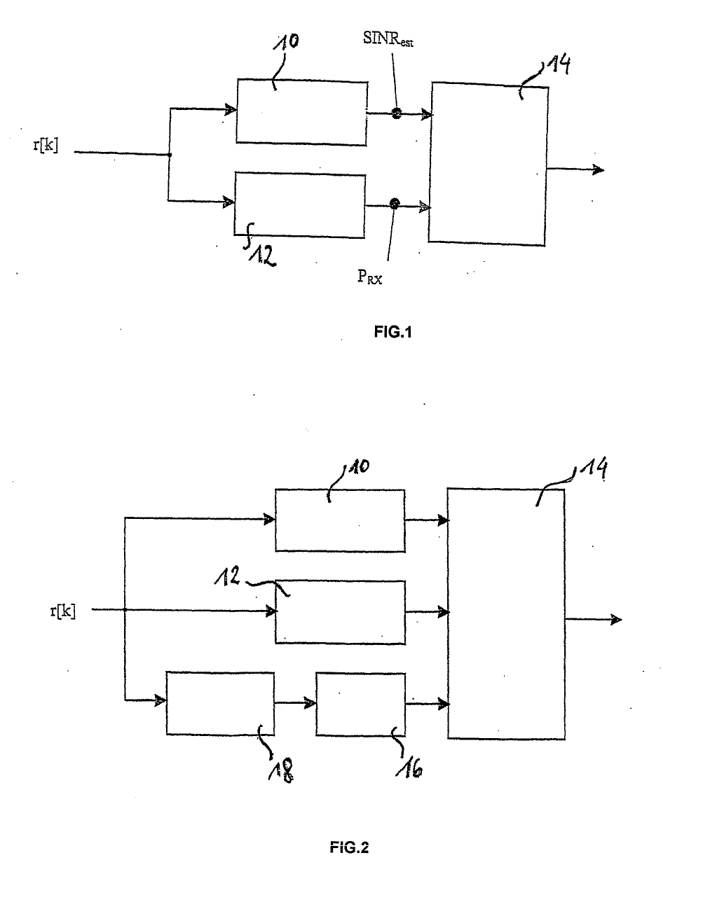

FIG. 2 shows in a block circuit diagram a second example of embodiment without antenna diversity;

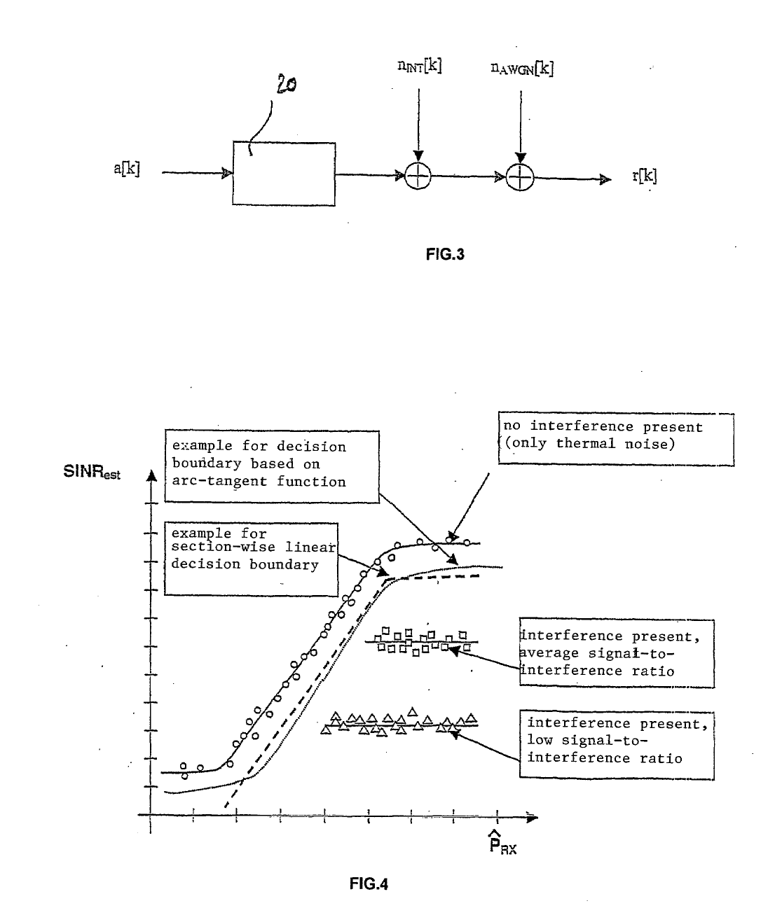

FIG. 3 shows in a schematic diagram a time-discrete block circuit diagram of a digital transmission;

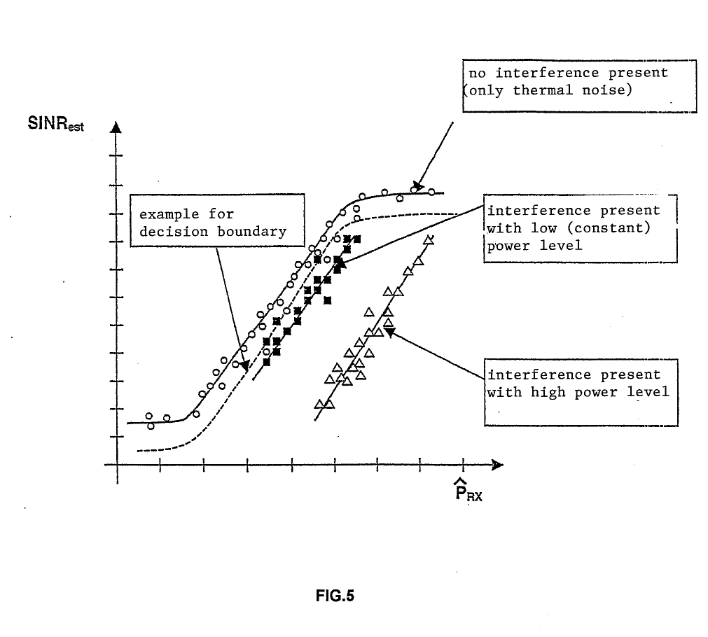

FIG. 4 shows in a schematic diagram a space stretched by one of the features (SINRₑₛₜ, \hat{P}_{RX}) with value pairs depicted by way of example as well as two possible decision boundaries;

FIG. 5 shows in a schematic diagram a further space stretched by the features (SINRₑₛₜ, \hat{P}_{RX}) with value pairs depicted by way of example as well as one decision boundary; and

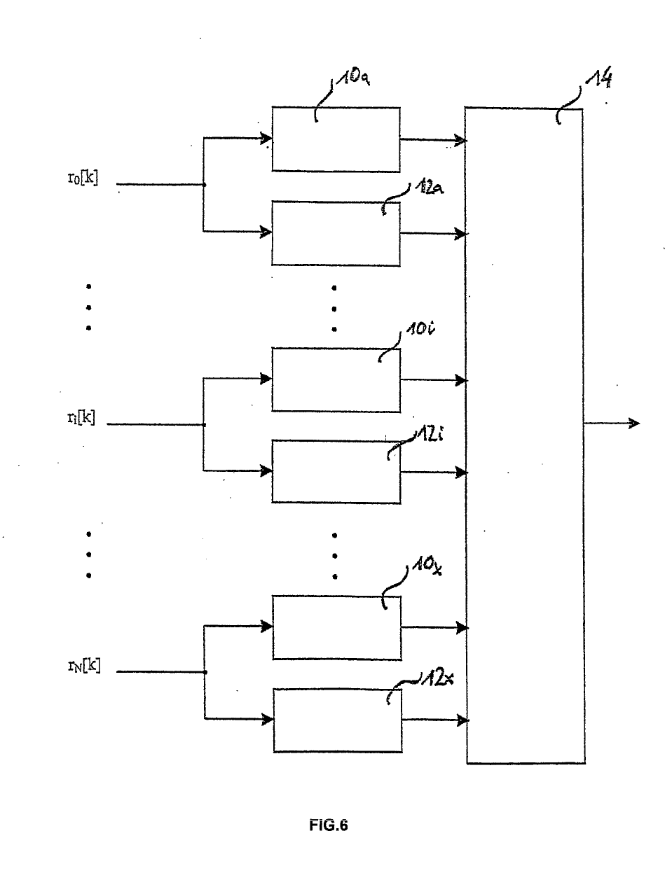

FIG. 6 shows in a block circuit diagram a further example of embodiment with N-fold antenna diversity.

In the following, the same reference characters without exception will be used for the same elements and similar elements of the various examples of embodiment. With respect to FIG. 1 the basic principle of the method according to the invention in a first simple embodiment consists of the fact that in a block 10 an estimate for the magnitude of “the signal-to-interference-plus-noise ratio (SINR)” and in a block 12 an estimate for the power P_{RX} of the received signal is determined and supplied to a decision unit 14, which makes a decision on these two features with respect to the occurrence of common channel and/or adjacent channel interference.

In a further embodiment schematically represented in FIG. 2 an estimate of the magnitude of “signal-to-residual-interference-plus-noise ratio” SRINR is incorporated as a third magnitude in block 16 when the decision is made (see FIG. 2), while optionally interference suppression takes place prior to the estimation in block 18.

In the following, first the meaning of the said estimates in connection with the present invention is explained.

### Estimate for the Power of the Received Signal (Block 12)

Each received signal of a real transmission system has noise components which are caused by thermal noise of the receiver or of a receiving device (for example antenna). Thus the receiver has a basic noise which in a first approximation within the usable bandwidth of the transmission channel under consideration corresponds to additive white Gaussian noise (AWGN). For the method according to the invention this assumption with respect to the type of the receiver noise, more particularly with respect to the spectral properties, needs to be satisfied only approximately. If a useful signal is received with the power P_{useful} without noise signals caused by the transmission channel or by another subscriber, the self-adapting instantaneous signal-to-noise ratio (SNR) of the received signal in essence depends on its receive power P_{RX}. The following holds under the assumption that the noise signal is additive and uncorrelated with the received signal:

$$SNR = \frac{{P}_{useful}}{{P}_{noise}} = \frac{{P}_{RX} - {P}_{noise}}{{P}_{noise}} \qquad ( 1 )$$

from which follows:

$$SNR = \frac{{P}_{RX}}{{P}_{noise}} - 1 \qquad ( 2 )$$

In most real transmission systems it may be assumed that the receiver noise having the power Pₙₒᵢₛₑ is known at least substantially. When the power of the received signal is known, there is the possibility to determine the signal-to-noise ratio for the case where there is no further disturbance for example as a result of common channel and/or adjacent channel interference sources. In real systems the actual (exact) values of the variables in the above equation can be replaced by their estimates.

$${SNR}_{est} = \frac{{\hat{P}}_{RX}}{{\hat{P}}_{noise}} - 1 \qquad ( 3 )$$

According to the state of the art there are numerous devices and methods for estimating the power of received signals which are known to the man of skill in the art and do not form the subject of the present invention. When the signal is present in the form of time-discrete sample values, the power of the signal can be estimated for example via establishing the variance of the signal sequence under consideration.

### Estimate for the Signal-to-Interference-Plus-Noise Ratio (SINR) (Block 10)

In the following is outlined a method of estimating the signal-to-noise-plus-interference ratio (SINR) preferred for this purpose, customary for the state of the art and known to the expert:

A transmission with pulse amplitude modulation (PAM) over a distorting channel, which generates intersymbol interference (ISI) can, as is known, be modeled in a time-discrete fashion in accordance with FIG. 3. The received signals sampled with the transmit symbol clock 1/T are evident as disturbance-affected convolution of the PAM transmit sequence a[k] with the impulse response h[k], see block 20 in FIG. 3 of the channel whose length is referred to as L:

$$r [ k ] = {\sum }_{κ = 0}^{L - 1} h [ κ ] a [ k - κ ] + n [ k ] . \qquad ( 4 )$$

Depending on the modulation method used the amplitude coefficients a[k] and the channel impulse responses h[k] are either purely real, purely imaginary or complex. PAM signals can for example also approximately describe binary CPM (continuous phase modulation) methods as described in P. A. Laurent “Exact and approximate construction of digital phase modulations by superposition of amplitude modulated pulses (AMP)”, IEEE Trans. on Commun., COM 34, 150-160, 1986, which are often used in mobile communication such as for example the GSM system because of their bandwidth capacity and their small peak value factor. With the amplitude coefficients a[k] it is assumed that they are a priori known in the receiver (what are called pilot or training symbols).

The time-discrete disturbance n[k] consists of two components:

n[k]=n_{WGN}[k]+n_{INT}[k] (5)

where n_{AWGN}[k] symbolizes the AWGN component, which is average-free, gaussian distributed and white (the latter being given when using a whitened matched filter as described in G. D. Forney Jr., “Maximum-Likelihood Sequence Estimation of Digital Sequences in the Presence of Intersymbol Interference”, IEEE Transactions on Information Theory, IT-18, 363-378, May 1972, or when using a general root-Nyquist filter as a time-continuous receiver input filter prior to the sampling. The disturbance as a result of n_{AWGN}[k] can thus physically mainly be led back to the thermal noise described above in the receiver input stage. n_{INT}[k] represents the potential disturbance as a result of interference signals.

Now in the receiver there is first an estimation of the channel impulse response ĥ[κ] based on the known symbol a[k], for which response various methods can be used according to the state of the art, which are known to a man of ordinary skill in the art and do not form a subject of the invention (for example described in S. N. Crozier, D. D. Falconer and S. A. Mahmoud “Least sum of squared errors (lsse) channel estimation”, IEE Proceedings-F, 138:371-378, August 1991).

Subsequently, based on the estimate of the channel impulse response, an estimate ŝ[k] is made of the disturbance component consisting of noise components and interference components in accordance with

$$\hat{s} [ k ] = {\hat{n}}_{AWGN} [ k ] + {\hat{n}}_{INT} [ k ] = r [ k ] - {\sum }_{κ = 0}^{L - 1} \hat{h} [ κ ] \cdot a [ k - κ ] . \qquad ( 6 )$$

According to equation 6 the estimated useful signal component is subtracted from the received signal and the result is interpreted as a disturbance signal.

Thus for the estimated signal-to-interference-plus-noise ratio SINRₑₓₜ the following holds:

$${SINR}_{est} = \frac{{\hat{P}}_{useful}}{{\hat{P}}_{noise} + {\hat{P}}_{INT}} = \frac{{\sum }_{κ = 0}^{L - 1} {\vert \hat{h} [ κ ] \vert}^{2}}{\frac{1}{M} {\sum }_{μ = 0}^{M - 1} {\vert \hat{s} [ μ ] \vert}^{2}} \qquad ( 7 )$$

where M is the number of the discrete values of the estimated disturbance signal used as a basis for the estimate.

The exact method for determining the estimated signal-to-interference-plus-noise ratio SINRₑₛₜ is not a component part of the invention, so that also other methods than the one described above can be used.

### Operation of the Decision Unit (Block 14)

In the following the operation of the decision unit (14) is outlined by means of a simple example. First it is assumed that in the received signal there is no further disturbance (for example caused by interference signals from other subscribers) apart from thermally caused receiver noise. For this case the value of the signal-to-interference-plus-noise ratio SINR determined in accordance with equation 7 by definition corresponds to the signal-to-noise ratio, in other words the following holds:

SINR=SNR. (8)

With equation 3 the following holds from now on:

$${SINR}_{est} = {SNR}_{est} = \frac{{\hat{P}}_{RX}}{{\hat{P}}_{noise}} + 1. \qquad ( 9 )$$

Assuming that \hat{P}_{RX}/\hat{P}ₙₒᵢₛₑ>>1, this describes an approximately linear correlation between the estimate for the power of the received signal \hat{P}_{RX} and the estimate SINRₑₛₜ determined in accordance with equation 7. This fact is outlined in FIG. 4.

If, in contrast, in addition to the thermally caused receiver noise, there is a disturbance that is additional to and uncorrelated with the useful signal and noise in the form of interference signals, the identity described in equation 8 is no longer approximately fulfilled. In the event of such a disturbance signal and a simultaneously relatively high input level, the following holds for example:

$$SINR = \frac{{P}_{useful}}{{P}_{noise} + {P}_{INT}} = \frac{{P}_{RX} - {P}_{noise} - {P}_{INT}}{{P}_{noise} + {P}_{INT}} << SNR \qquad ( 10 )$$

and thus for the estimates

$${SINR}_{est} << \frac{{\hat{P}}_{RX}}{{\hat{P}}_{noise}} + 1 \qquad ( 11 )$$

Thus for this case of an occurring disturbance signal, the value pairs having the estimates (SINRₑₛₜ, \hat{P}_{RX}) are on average and with respect to the ordinate SINRₑₓₜ below the function described by equation 9 (see FIG. 4).

### Determining the Decision Boundary

With respect to the decision about the presence of a disturbance as a result of common channel and/or adjacent channel interference, basically two types of erroneous decisions are possible besides the error-free recognition strived for.
The received signal contains a disturbance that erroneously is not detected (first type of error)
The received signal contains no such disturbance, but nevertheless a decision is erroneously made as to the presence of such a disturbance (second type of error).

In a real transmission system generally a completely error-free detection will usually not be feasible. Therefore, the decision unit has for its object to minimize the erroneous decisions described above and which are partly unavoidable depending on the system. Therefore, in order to optimize the performance of the whole transmission system it may be necessary to keep either type of error below a selectable probability, while the other occurrence of error may have a distinctly larger probability (asymmetrical distribution of errors).

For the simple example of embodiment described above having two characteristic features, the value pairs of the input variables (SINRₑₓₜ, \hat{P}_{RX}) of the decision unit are situated in a two-dimensional space (plane). The decision unit particularly has for its object to separate this space into decision areas which correspond to the presence or absence of a common channel and/or adjacent channel interference source. In the present simple example of embodiment clarified by FIG. 1 and FIG. 4, a separation of the space into two areas can be effected for example by means of a section-wise linear function. In accordance with the division of the value pairs represented in FIG. 4 by way of example, for separating the two areas, however, also other functions can be used such as for example an arc-tangent function.

FIG. 5 shows a similar case by way of example where the sets of dots of the value pairs overlap, so that a complete separation of the areas is no longer possible.

With reference to the examples shown in FIG. 4 and FIG. 5 it may be recognized that as regards the assignment of the value pairs (SINRₑₛₜ, \hat{P}_{RX}) to the decision areas, no generally restricting assumptions can be made. The decision areas particularly depend on the accurate arrangement and the properties of the transmission system under consideration. Both linear and non-linear functions or relations respectively for delimiting the decision areas from each other can be used. This expressly includes also non-linear classification methods, which are known by the generic term of “artificial neural networks”. In addition, it may prove to be advantageous to define the decision areas in a time-variant fashion, i.e. to vary them in dependence on further parameters of the transmission system (for example temperature), which further parameters change the properties of the receiver (for example thermal noise of the first amplifier stage).

### Incorporation of Further Characteristic Features in the Decision-making Process

### Estimate for the Signal-to-Residual-Interference-plus-Noise Ratio (SRINR)(Block 16)

For a further improvement of the efficiency of the decision unit, a further preferred embodiment may have for a further characteristic feature the estimated signal-to-residual-interference-plus-noise ratio (SRINR) included in the decision-making process. For determining this characteristic feature, in block 18, see FIG. 2, the components of one or more dominant disturbing signals are removed from the received signal as far as possible. While often correctly assuming in real systems that the useful signal and the disturbing signals are incorrect, we have:

$$SRINR = \frac{{P}_{useful}}{{P}_{RI} + {P}_{noise}} , \qquad ( 12 )$$

where

P_{RI}=P_{RX}−P_{Nutzsignal}−P_{dominterf}−Pₙₒᵢₛₑ (13)

represents the power of the residual interference, that is, of the disturbance components still left in the received signal, not suppressed or removed.

Determining the characteristic feature SRINR thus requires a suppression of dominant disturbing signal components having the power P_{dominterfer} or knowing their magnitude (see FIG. 2). This is not a subject of the present method according to the invention, it is true, but nevertheless a preferred approach in this respect will be coarsely outlined hereinafter:

A possibility of estimating the SRINR consists of the fact that under the hypothesis of a disturbance occurring as a result of common channel and/or adjacent channel interference sources, interference suppression is carried out. For this purpose for example methods according to the teaching of EP 1 221 780 could be used. According to these methods a dominant disturbance signal, possibly occurring in the received signal, is removed so that except for the noise power component having power Pₙₒᵢₛₑ, only a non-suppressed residual interference component having power P_{RI} is left. After the interference has been suppressed, the approach provides, for example according to equation 7, the desired estimate SRINRₑₛₜ. It is obvious that when a dominant disturbance source occurs and is successfully suppressed, the value of the signal-to-residual-interference-plus-noise ratio (SRINRₑₛₜ) is expected to clearly deviate from the value of the signal-to-interference-plus-noise ratio (SINRₑₛₜ). For the case where the received signal does not contain a disturbance signal, interference suppression will not take any effect, so that similar magnitudes can be expected for either value. This makes it clear that the said characteristic feature (signal-to-residual-interference-plus-noise ratio) can represent a further relevant magnitude for the decision unit.

### Realization of the Decision Unit Having Three or More Input Features

If three or more features are incorporated in the decision-making process, a three-dimensional or higher-dimensional space is spread out by these features, which space is subdivided into decision areas by the decision unit similarly to the case where there are two characteristic features. The choice of the decision areas and thus the respective, generally non-linear, imaging function takes place in dependence on the respective transmission system under consideration. For the case of three decision features, a possible preferred embodiment is that the sub-areas are delimited by parts of the plane (area-wise linear separation). The boundaries of the decision areas, however, can also be described by suitable non-linear images. Similarly, in the case of two-dimensional spaces, artificial neural networks can be used here.

### Application in the Case of Antenna Diversity

If N-fold antenna diversity occurs in the receiver (for example in a mobile receiver), the features described above (blocks 10a to 10x and blocks 12a to 12x) can individually be recovered and applied to a common decision unit 14, as is schematically shown in FIG. 6 on the basis of the simple embodiment shown in FIG. 1 This decision unit 14 then makes a decision about the presence of common channel and/or adjacent channel interference based on the said features. The extension to more than two features can take place accordingly.

### List of Formula Elements:

SNR Signal-to-noise ratio
SNRₑₛₜ estimated signal-to-noise ratio
SINR signal-to-interference-plus-noise ratio
SINRₑₛₜ estimated signal-to-interference-plus-noise ratio
SRINR signal-to-residual-interference-plus-noise ratio
SRINRₑₛₜ estimated signal-to-residual-interference-plus-noise ratio
a[k] amplitude coefficient of the transmit or training symbols
r[k] time-discrete received signal
rᵢ[k] time-discrete received signal of the i^{th} channel in the case of antenna diversity
n[k] time-discrete disturbance component (total disturbance)
n_{AWGN}[k] time-discrete disturbance component caused by additive noise
n_{INT}[k] time-discrete disturbance component caused by interference
ŝ[k] estimated sequence of the disturbance component in the time-discrete received signal
h[k] channel impulse response of the useful signal
ĥ[k] estimated time-discrete channel impulse response of the useful signal
L: number of coefficients of the channel impulse response ĥ[k]
T transmit symbol interval
M length of the evaluated receiving frequency
N number of receiving antennas
P_{RI} power of the residual interference (after noise suppression)
P_{RX} power of the received signal
\hat{P}_{RX} estimated power of the received signal
P_{useful} power of the useful signal component in the received signal
\hat{P}_{useful} estimated power of the useful signal component in the received signal
P_{domInterf} power of the dominant noise component which could be removed by suitable interference suppression
Pₙₒᵢₛₑ power of the noise component in the received signal
\hat{P}ₙₒᵢₛₑ estimated power of the noise component in the received signal
P_{INT} power of the interference component in the received signal
\hat{P}_{INT} estimated power of the interference component in the received signal

1. A method for digital data transmission, in which the transmission is effected by modulating a carrier frequency and is disturbed by at least two different types of disturbance, the method comprising the following steps at the receiving end:
a1) determining an estimate for the power of the received signal;
a2) determining an estimate for the signal-to-interference-plus-noise ratio of the received signal;
b) supplying at least the estimates determined in the steps a1) and a2) to a decision unit, which decides on at least one dominant type of disturbance based on at least one predefinable decision criterion.

2. A method as claimed in claim 1, characterized by the following further step:
a3) determining an estimate for the signal-to-interference-plus-residual-noise ratio, in which in step b) also the estimate of the decision unit determined in step a3) is supplied.

3. A method as claimed in claim 2, characterized in that prior to step a3) at least a measure for interference reduction, more particularly for interference suppression, is applied to the received signal.

4. A method as claimed in one of the preceding claims, characterized by the following further step:
c) equalization of the received signal based on the at least one dominant type of disturbance determined in step b).

5. A method as claimed in claim 4, characterized in that the transmission is disturbed by noise, on the one hand, and common channel and/or adjacent channel interference, on the other.

6. A method as claimed in one of the preceding claims, characterized in that in the event of antenna diversity at least the steps a1), a2) and b), or the steps a1), a2), a3) and b) are carried out for each received sub-signal.

7. A method as claimed in claim 6, characterized in that furthermore the step c) is carried out for each received sub-signal.

8. A device for receiving digital data by means of modulation of a carrier frequency of transmitted data, the method comprising:
a device (12) for determining an estimate for the power of the received signal;
a device (10) for determining an estimate for the signal-to-interference-plus-noise ratio of the received signal; and
a decision unit (14), which is coupled to the device (12) for determining an estimate for the power and to the device (10) for determining an estimate for the signal-to-interference-plus-noise ratio and is arranged for determining at least one dominant type of disturbance based on the estimates found on the basis of at least one predefinable decision criterion.

9. A semiconductor module in which the method as claimed in one of the claims 1 to 7 is stored.
